(19) United States
(12) Patent Application Publication
(10) Pub. No.: US 2014/0067282 A1
(43) Pub. Date: Mar. 6, 2014

(54) METHOD FOR THE LASER SPECTROSCOPY OF GASES

(71) Applicant: SICK AG, Waldkirch/Breisgau (DE)

(72) Inventors: Thomas BEYER, Freiburg i. Breisgau (DE); Julian EDLER, Emmendingen (DE)

(73) Assignee: SICK AG, Waldkirch/Breisgau (DE)

(21) Appl. No.: 14/013,788

(22) Filed: Aug. 29, 2013

(30) Foreign Application Priority Data
Sep. 3, 2012 (DE) 102012215594.5

(51) Int. Cl. G01N 21/25

(52) U.S. Cl. CPC G01N 21/255
USPC 702/24; 702/28

(57) ABSTRACT

A method of determining a concentration of a gas in a sample and/or of the composition of a gas by means of a spectrometer includes measuring an absorption signal of the gas as a function of the wavelength. The wavelength substantially continuously runs through a wavelength range and is superimposed by a harmonic wavelength modulation, wherein the influence of the wavelength modulation on the absorption signal via the light source modulation properties and the detection properties of the spectrometer is dependent on the device properties of the respective spectrometer. The method includes converting the absorption signal into at least one first derivative signal; deriving a gas concentration measurement parameter from the first derivative signal; determining the concentration and/or composition of the gas from at least the gas concentration measurement parameter and from a calibration function compensating for influences of state variables of the gas and of the spectrometer properties.

The invention relates to a method of determining a concentration of gases in a sample and/or the composition of a gas by means of a spectrometer. The method comprises the measurement of an absorption signal, the conversion of the absorption signal into a derivative signal, the derivation of a gas concentration measurement parameter from the derivative signal and the determination of the concentration and/or composition of the gas from the gas concentration measurement parameter and from a calibration function. The invention also relates to a spectrometer for the carrying out of such a method.

It is known for the examination of a gas sample as to its composition and in particular as to the concentration of a specific gas of the sample to derive this information using spectroscopy with reference to the specific absorption of electromagnetic waves such as light through different gases or gas mixtures. Laser spectrometers are typically used for this purpose in which the light of a laser is irradiated through the sample which is located in a measurement space, for example, or is conducted through a measurement space. With a known extent of the sample in the direction of laser propagation (extent of the measurement space), the absorption coefficient depending on the wavelength of the irradiated laser light can be determined in accordance with Lambert-Beer's law. A conclusion can be drawn on the concentration of a gas or its portion in the sample from the comparison of an absorption spectrum obtained in this manner using spectra known for different gases.

Different gases have different typical wavelengths at which they have especially high absorption. The corresponding maxima in the absorption spectrum or minima in the transmission spectrum are ideally sharp absorption lines. Due the blur relationship of the pressure of the gas and of the temperature dependent Doppler effect, real absorption lines are, however, widened to form a specific absorption line shape. As a rule, it substantially has a Voigt profile which results on the folding of a Gaussian curve, which is typical for a temperature dependent Doppler broadening, with a Lorentz curve whose width is typically pressure dependent.

A whole wavelength range is therefore examined for the measurement of one or more such absorption lines in an absorption spectrum in that the laser of the spectrometer, for example, runs through a linear wavelength ramp. In this respect, the linear ramp can also be part of a sawtooth function or of a triangle function to run through the same wavelength range a plurality of times.

An extension of this direct spectroscopy is represented by wavelength modulation spectroscopy in which the described substantially continuous running through of the wavelength range is superimposed by a modulation of the wavelength which is fast with respect to it. This wavelength modulation is typically sinusoidal at a fixedly predefined modulation frequency. Since the absorption spectrum acts as a transfer function, the wavelength modulation of the laser light is converted due to the absorption by the sample into a correspondingly modulated absorption signal which is recorded by the spectrometer.

The portions at the modulation frequency and the at whole-number multiples of the modulation frequency are determined from the modulated absorption signal for the evaluation. This can take place, for example, using phase-sensitive amplifiers, typically lock-in amplifiers, or by calculation processing, for instance by means of a Fourier analysis. The signals thus determined, which indicate the portion of the modulated absorption signal at the modulation frequency or at a multiple of the modulation frequency for every wavelength, are also called derivative signals since they substantially, i.e. in particular for the borderline case of small modulation amplitudes, correspond to the (mathematical) derivations of the absorption spectrum. The portion at the modulation frequency itself in this respect corresponds to the first derivation and is also called a 1f signal; the portion at double the modulation frequency is called a 2f signal and corresponds to the second derivation, etc.

On the basis of this relationship, the derivative signals substantially contain the same information which is also contained in the direct absorption signal so that the gas concentration or the sample composition can also be determined from a respective derivative signal. The advantage of the use of the derivative signals is in this respect that the information to be determined is displaced into higher frequency ranges in which the signal to noise ratio is as a rule better than in low frequency ranges. In addition, background signals which falsify the absorption spectrum as base lines to be deducted can be partly eliminated by the derivative signals. For example, the influence of a constant offset is eliminated in the 1f signal; in the 2f signal the influence of any desired linear base lines, etc. The higher the degree of the derivative signal, the more complex base lines are filtered from the signal, the lower the signal intensity also becomes, however. For this reason, the 2f signal is typically used as a good compromise between the advantages and disadvantages of higher derivations for the evaluation.

A method for gas analysis using laser spectroscopy according to the principle of wavelength modulation spectroscopy is described in EP 1 873 513 A2. It is in particular represented therein how, as part of the signal evaluation, conclusions can be drawn on parameters such as the concentration of a gas from the 2f signal of an absorption spectrum. Furthermore, the variability of marginal conditions is taken into account by factors determined as part of a calibration such as a calibration factor.

It is problematic in the use of wavelength modulation spectroscopy that the wavelength of the laser is as a rule set by a current intensity applied at the laser. The modulation of the wavelength is accordingly a consequence of a corresponding current modulation. The dependence of the wavelength on the named current intensity is in this respect, however, only theoretically constant. In practice, there is a complex relationship differing from laser to laser. The influence of the wavelength modulation on the absorption signal depends on device properties such as the properties of the laser over this relationship which in the following should be designated as the light source modulation properties of the spectrometer.

The wavelength modulation is detected using a detector. In practice, this is a complex relationship differing from spectrometer to spectrometer between the actual laser wavelength modulation and the measured laser wavelength modulation. This relationship depends on the properties of the spectrometer and of the electronics of the spectrometer used and should be called the detection properties of the spectrometer in the following. The device properties can therefore be divided into light source modulation properties and detection properties. The light source modulation properties and/or the detection properties of the spectrometer moreover vary over time and therefore have to be recalibrated regularly for each spectrometer. The time period between two calibrations is in this respect typically shorter than one year.

The calibration takes place by the determination of a calibration function which serves top take account of different parameters which have a falsifying influence on the determination of the actual gas concentration from the measurement signal and to liberate the actual measurement parameter from these influences. All these influence parameters therefore enter into the calibration function. Specifically, the calibration function of a spectrometer for the wavelength modulation spectroscopy must take account of state variables of the sample such as its temperature, its pressure and influences of carrier gases on the measurement. In addition, the device properties of the spectrometer have to be taken into account, in particular via the light source modulation properties and the detection properties of the spectrometer. In this manner, the influences of these parameters on the measurement parameter can be eliminated so that the measurement parameter can ultimately indicate the gas concentration dependent on the number of particles of the examined gas or the gas compensation without falsification.

To determine such a calibration function (calibration), its dependence on the parameters falsifying the measurement result must be determined. The carrying out of the calibration therefore as a rule comprises the measurement of absorption signals and derivative signals at a plurality of test cuvettes with reference samples whose concentration or composition equally has to be exactly known as the respective current state variables of the sample as well as the current intensity and wavelength of the spectrometer. These measurements have to be carried out with numerous combinations of these parameters, for instance at precisely set pressures and temperatures of the respective sample by which the total working range of the spectrometer is covered. The regular calibration is prone to error and time-consuming or causes regular costs when a service provider is commissioned with the carrying out, due to the associated effort, in particular when carried out by an unpracticed user.

It is therefore an object of the invention to provide a method of determining a concentration of a gas in a sample and/or the composition of a gas in a sample by means of a spectrometer which is simpler, less prone to error and less time-consuming.

This object is satisfied by a method having the features of claim 1 and in particular in that the calibration function comprises a parent calibration function and a device calibration function, wherein the state variables of the gas and one or more gas concentration measurement parameters derived from respective derivative signals enter into the parent calibration function, said gas concentration measurement parameters being selected so that the light source modulation properties of the spectrometer are substantially compensated and wherein the device calibration function takes account of the detection properties of the respective spectrometer. The object is correspondingly satisfied by a spectrometer for carrying out the method in accordance with the invention. Preferred aspects are the subject of dependent claims.

Values are to be understood as gas concentration measurement parameters in this respect which can be derived from respective derivative signals, for example in that they indicate an area or a similar measure which can be determined in the derivative signals and which contain information on the gas concentration to be measured and/or on the composition of the gas to be measured as measurement parameters. In accordance with the invention, a plurality of gas concentration measurement parameters can also enter into the parent calibration and can be derived in a different manner from the same or also from different derivative signals.

The state variables of the gas can explicitly enter into the parent calibration function separately from the gas concentration measurement parameters. Provision can, however, alternatively also be made that some or all state variables of the gas do not explicitly enter into the parent calibration function, but rather only in that they are contained in the gas concentration measurement parameters entering into the parent calibration function.

The method in accordance with the invention is characterized in that the calibration function for determining the concentration and/or composition of the gas from gas concentration measurement parameters derived from respective derivative signals, which calibration function is provided for the purpose of compensating falsifying influences, does not comprise a single calibration function, but rather two different part calibration functions which are independent of one another, namely a parent calibration function and a device calibration function. These two functions differ very substantially from one another in accordance with the invention to the extent that the state variables of the gas and the gas concentration measurement parameters enter into the parent calibration function, that is such parameters which describe current physical states of the gas in the measurement or are at least derived therefrom, while only the detection properties of the respective spectrometer are taken into account by the device calibration function which detection properties can in particular be different from spectrometer to spectrometer and can change for the same spectrometer over specific periods, for instance in the order of magnitude of a plurality of months.

The two named part calibration functions are in particular separate from one another to the extent that they do not take themselves account of the values taken into account in the respective other part calibration function. This is possible in that the values entering into the parent calibration function are selected just so that the light source modulation properties of the spectrometer are substantially compensated. In this manner, the parent calibration function is so-to-say decoupled from the device properties since, on the one hand, the light source modulation properties are compensated and, on the other hand, the detection properties of the spectrometer are taken into account independently thereof in the device calibration function.

The gas concentration measurement parameters, which are derived from respective derivative signals, are in this respect measurement parameters reflecting the concentration of the gas which are still to be liberated from falsifying influences by the calibration function split into two to reflect the concentration or compensation of the gas as exactly as possible.

The determination of the gas concentration can in this respect mean the determination of the gas concentration in a sample, which terminology should also include the determination of the concentration of a gas component in a gas or the determination of the composition of a gas.

On a use of the two part calibration functions, the influence of all relevant values on the measurement result can be compensated just as reliably by the use of a parent calibration function and a device calibration function as would also take place by a single calibration function. However, unlike the use of a single calibration function, the calibration of the spectrometer is substantially simplified by the division into a parent calibration function and a device calibration function. On the one hand, the determination of the parent calibration function only has to be carried out once for each spectrometer, and in particular only once for a plurality of spectrometers of the same type, e.g. of the same construction, since it describes fixed physical relationships. On the other hand, the determination of the device calibration function, which is variable, must admittedly take place regularly, but is limited to a few properties of the spectrometer and can therefore be carried out substantially simpler and faster.

The parent calibration function can already be determined by the manufacturer, for example. A user of the spectrometer is thereby in particular relieved of this part of the carrying out of the calibration which flows into the parent calibration and which is associated with a great effort and/or cost since it can e.g. required measuring a high number of reference samples in test cuvettes at a plurality of pressures and temperatures, which have to be set precisely, over the total range of use of the spectrometer. The determining of the device calibration function, which remains as a regular calibration for the user, is substantially simpler in comparison with this and can therefore be carried out with less proneness to error so that it can also be carried out fast and correctly by an unpracticed user.

The parent calibration function and/or the device calibration function can, for Instance, be applied to the one or more gas concentration measurement parameters and can directly output a concentration or composition of the gas free from the influences of the state variables of the sample and of the device properties of the spectrometer. They can alternatively serve to derive the one or more gas concentration measurement parameters from the derivative signal in the first place and simultaneously to liberate them from falsifying influences. In a preferred embodiment, the parent calibration function and/or the device calibration function deliver a (respective) correction value, with the falsifying influences being eliminated by multiplication of the one or more gas concentration measurement parameters by the correction value. The device calibration function can e.g. also deliver parameters which are then used in the parent calibration function to eliminate the falsifying influences on the measured value.

It is preferred if the at least one derivative signal, which is determined by converting the measured absorption signal, is normed to a value proportional to the light intensity. The measurement system is thereby independent of contamination of the optics used and of dust in the beam path.

The state variables of the gas which enter into the parent calibration function preferably comprise a pressure, a temperature and/or a carrier gas influence, i.e. the influence of further gases in the sample on the absorption spectrum and thus on an absorption signal or derivative signal of the sample. The state variables can, however, also comprise further, and substantially all such parameters which describe physical states of the gas. In addition, additional measurement parameters can enter into the parent calibration function which are generated directly from the measurement signals. The carrier gas influence in particular does not necessarily have to be present as a state variable.

It is furthermore advantageous if the detection properties of the respective spectrometer taken into account by the device calibration function are properties of electronics of the spectrometer. The detection properties of the respective spectrometer can, however, in particular also comprise all other properties specific to the device and such properties which have an influence on the relationship between the actual and the measured lase wavelength modulation. Information on the detection properties of the spectrometer advantageously thus only flow into the device calibration function, but not into the parent calibration function.

In a preferred further development of the method in accordance with the invention, the device calibration function is determined by a two-point calibration. A two-point calibration is substantially restricted to two measurements being carried out, with the measurements differing by two different (reference) samples and/or in one or more state variables of the sample(s). The two “points” of the two point measurement to be distinguished can be freely selectable or predefined. The “points” can, for example, be defined by two test cuvettes having two reference gases or reference gas compositions and/or by two defined pressures and/or temperatures of the same or of different samples. The carrying out of the device calibration can then be carried out particularly simply, reliably and fast due to these only two measurements.

It is further particularly preferred if the two-point calibration comprises a measurement of the gas or of a reference gas with a first and/or second gas concentration. The named first gas concentration preferably corresponds to a gas concentration of 0% and the named second gas concentration corresponds to a gas concentration of 70% of a maximum reliably measurable concentration of this gas. The maximum reliably measurable concentration of the gas is in this respect defined by the application range with respect to the gas concentration for which the spectrometer is configured. Test cuvettes which contain the samples of the gas or of a reference gas at the named first or second gas concentration can, for example, be included with the spectrometer by the manufacture of the spectrometer for the simple carrying out of the regular determination of the device calibration function by the user.

On the carrying out of a measurement using the spectrometer at a sample, the measurement signals, that is in particular derivative signals derived from the absorption measurement of the sample, enter into the parent calibration function, in addition to the state variables of the sample, in the form of gas concentration measurement parameters. So that the parent calibration function can deliver an amount from this which compensates the light source modulation properties of the spectrometer for the determination of the concentration and/or composition of the gas free of falsifying influences, such gas concentration measurement parameters have to enter into the parent calibration function by which the specific influence of the light source modulation properties on the form of the measurement signal can be calculated out.

On a constant absorption line shape, in which only the height of the absorption line can vary in dependence on the light source modulation properties of the spectrometer, a respective measurement parameter could e.g. be determined from at least two derivative signals to obtain a measurement parameter from this which is characteristic for the concentration and/or composition to be determined and in which the light source modulation properties of the spectrometer are compensated. For, depending on the wavelength modulation, characteristic combinations of the derivative signal values occur therefor. Since, however, the absorption line shape is not constant at different environmental conditions such as the temperature and pressure or varying mixtures with carrier gases, but rather in particular changes its shape with respect to its width, a further measurement parameter is required to be able to calculate the wavelength modulation of the spectrometer out of the measurement signal in an unambiguous manner.

In particular those measurement parameters can be considered as measurement parameters which enter into the parent calibration function in addition to the above-named state variables which are a measure for the derivative signal and a measure for the ratio of two derivative signals as well as a measure for the broadening of the absorption lines. Such gas concentration measurement parameters are then suitable to compensate the light source modulation properties of the spectrometer. In the following, such suitable gas concentration measurement parameters will be described with reference to advantageous embodiments.

In a preferred embodiment, at least one area of the first derivative signal or a value proportional to the area of the first derivative signal enters into the parent calibration function as the gas concentration measurement parameter. It is further preferred if the absorption signal is not only converted into a first derivative signal, but also into a second derivative signal different from the first derivative signal and at least one ratio of an area of the first derivative signal and of an area of the second derivative signal enters into the parent calibration function as the gas concentration measurement parameter. The area of a signal can for example be the area of a peak present in the path of the signal.

The expression “first derivative signal” is in this respect not restricted to the derivative signal which corresponds to the first derivation of the absorption signal (1f signal), but can designate any one of the derivative signals (1f, 2f, etc.). The same applies to the expression “second derivative signal” which is not to be understood as limited to the 2f signal.

The area of the first derivative signals is preferably derived from the spacing of a maximum of this derivative signal from a minimum of this derivative signal or from areas enclosed between the x axis and the respective derivative signal. The same applies, where applicable, to the area of the second derivative signal. If the derivative signal whose area is to be determined is a derivative signal which approximately corresponds to an even-number derivation of the absorption signal (2f, 4f, etc.), this signal as a rule has a dominating maximum at the central wavelength of the respective absorption line of the gas and has a respective minimum symmetrically at both sides of this maximum. The value-based spacing of the central maximum from one of the two minima or from an average value of the two minima can be used for determining the named area of this derivative signal. Derivative signals which approximately correspond to odd-number derivations of the absorption signal (1f, 3f, etc.) are as a rule point-symmetrical to the central wavelength of the respective absorption line and have a zero crossing at the central wavelength, a maximum adjacent thereto on the one side as well as a minimum adjacent thereto on the other side of the zero crossing. In this case, the value-based spacing of this maximum and of this minimum can be used for the determination of the named area.

For the event that an only slight broadening of the absorption line can be assumed on the basis of pressure, temperature or further influences, these gas concentration measurement values (area and area ratio) would already be sufficient as values entering into the parent calibration function. For the more general case, a further gas concentration measurement parameter derived from the derivative signals is required.

It is therefore further advantageous if at least one width of the first derivative signal enters into the parent calibration function as the gas concentration measurement parameter. This dependence of the parent calibration function on a width of a derivative signal can supplement the dependence on an area or on an area relationship of the derivative signals so that ultimately the influences of the state variables on the measurement signal can be calculated out independently of the light source modulation properties of the spectrometer for very different absorption line shapes with respect to their position and their broadening.

The named width of the first derivative signal is preferably a full width at half maximum of an extreme of this derivative signal or a spacing between two extremes, between two zero crossings or between an extreme and a zero crossing of this derivative signal. Substantially all striking and clearly identifiable points of the derivative signal can therefore be used for determining the width which make it possible to determine the degree by which the absorption line is broadened by different possible influences.

A parent calibration function, which, as shown, takes account of the areas or of the ratio of the areas of at least two derivative signals as well as of the width of one of the derivative signals, thus substantially detects all relevant influences of state variables of the sample on the absorption line shape, in particular including the temperature-dependent double broadening of the Gaussian portion and the pressure-dependent broadening of the Lorentz portion in the absorption line. The parent calibration function is thus suitable, once it has been set up, to provide a contribution which takes account of the influence of the state variables, but not of the influence of the detection properties of the spectrometer, to eliminating these falsifying influences on the value to be measured from the state variables of the sample as well as from the gas concentration measurement parameters, in particular from areas and widths of the derivative signals, derived from respective derivative signals. It is above all possible to eliminate the influence of the light source modulation properties of the spectrometer on the measurement signal using these state variables so that this influence no longer has to be taken into account in the device calibration function, but this can rather be restricted to the detection properties.

For the determination (calibration) of the parent calibration function, which only has to take place once for a respective spectrometer, advantageously only once for a series of spectrometers of the same kind, a preferred embodiment of the method in accordance with the invention provides that the parent calibration function is determined by a plurality of measurements on the presence of different combinations of state variables of a respective sample. In this respect, the individual state variables are advantageously graduated as finely as possible over the total application range of the spectrometer by the different combinations of state variables to be able to determine the parent calibration function as exactly as possible.

Since measurements are carried out for numerous combinations of state variables of the sample, the parent calibration function can be matched, for example as a multidimensional polynomial or as another mathematical function, to a data set acquired in this manner. It is equally possible that the parent calibration is not a continuously defined function, but is defined in the manner of a look-up table by a plurality of sampling points between which, for example, rounding or interpolation can take place. It can be shown mathematically for absorption lines which are substantially pure Lorentz curves that such an empirically determined parent calibration function is suitable to compensate the light source modulation properties of the spectrometer by a suitable choice of the gas concentration measurement parameters entering into it. It is likewise shown that the parent calibration function thus determined substantially has this desired property for absorption lines having a Voigt profile which are a mixture of Lorentz and Gaussian curves, as is the case as a rule.

The invention also relates to a spectrometer which is suitable for carrying out the method in accordance with the invention, in particular in accordance with one of the shown embodiments. Such a spectrometer can, for example, carry out the respective method very largely in an automated or partly automated fashion, with in the in last-named case a user being able to be guided through individual steps of the method, for Instance by means of a display device of the spectrometer. The spectrometer can furthermore comprise a processor unit, for example a microprocessor, on which the method in accordance with the invention or parts thereof are stored as routines. In addition, a routine can preferably be provided for the carrying out of the determination of the device calibration function for the guiding of a user for carrying out this determination. Provision is made in an embodiment of the spectrometer that state variables of the sample of a gas to be measured are input by a user. Alternatively, in a preferred embodiment, the spectrometer comprises sensors in order themselves to determine at least some of these state variables, such as the temperature and pressure of the sample.

It is advantageous for carrying out the method in accordance with the invention if the wavelength of the light source of the spectrometer can be precisely set and can ideally be varied continuously over a large wavelength range for the wavelength-dependent measurement of the absorption signal. To obtain light of a sharp wavelength, filters or grids can, for example, be Inserted before a conventional light source.

In a particularly preferred embodiment, the spectrometer comprises a laser as a light source and the absorption signal results from the absorption of light of this laser by the gas. The use of a laser makes it possible to obtain light of high intensity with a sharply defined wavelength in a simple manner. The wavelength of this laser is preferably moreover adjustable. In particular diode lasers are suitable for this purpose, for instance in the manner of a vertical cavity diode laser or a distributed feedback diode laser which are preferably used in a spectrometer in accordance with the invention.

It is furthermore preferred if the parent calibration function is substantially permanently stored in the spectrometer. The spectrometer can comprise a memory unit for this purpose, for example. The parent calibration function can be stored, for example, as a definition of a mathematical function or as a multidimensional matrix of sampling points in the manner of a look-up table. Roundings or interpolations can be provided for determining values between the sampling points. The permanent storage of the parent calibration function in the spectrometer makes it possible that the determination of the parent calibration function takes place once, for instance at the manufacturer's, and is then present in an accessible manner in the spectrometer itself for all further uses of the spectrometer. Since a repetition of the determination of the parent calibration is not provided as a rule, the parent calibration can be stored in the spectrometer in a write-protected manner.

The device calibration function can be stored in the spectrometer in a similar manner to the parent calibration function. Since the device calibration function, however, has to be redetermined regularly as a rule, it is preferably not permanently stored, but can rather be overwritten.

The invention will be explained in the following with respect to the enclosed schematic Figures. There are shown:

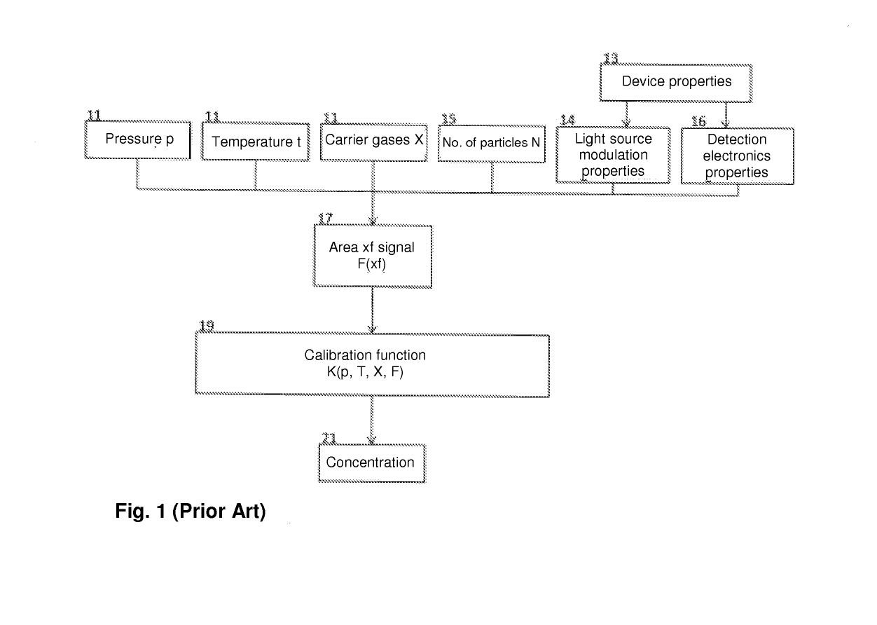

FIG. 1 in a schematic representation, which values enter into the calibration function in accordance with the prior art via which relationships during the running of a measurement; and

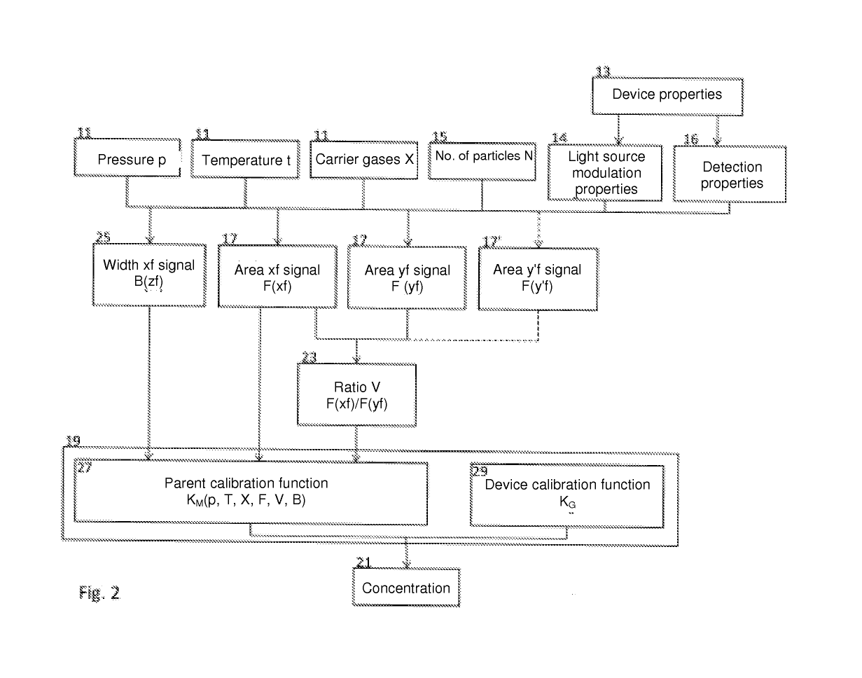

FIG. 2 in a schematic representation, which values enter into the calibration function in accordance with an embodiment of the method in accordance with the invention via which relationships during the running of a measurement, said calibration function split into a parent calibration function and a device calibration function.

The respective calibrations to be carried out before the measurements (once or regularly) for determining the calibration functions 19, 27, 29 are not shown in the Figures. In the measuring routines shown in FIGS. 1 and 2, the respective calibration functions 19, 27, 29 are already determined, i.e. they already contain in stored form the respective information on the functional relationships how different influences, in particular the state variables 11 of the gas and of the device properties 13 of the spectrometer, act on the measurement influence 21.

The schematic representation in FIG. 1 starts from state variables 11 of a sample to be measured, from device properties 13 of a spectrometer used for the measurement and from a measurement parameter 15 which is based on the concentration and/or on the composition to be measured of a gas of the sample. The state variables here are the pressure p, the temperature T and a carrier gas influence X. The device properties 13 of the spectrometer are substantially properties of the electronics and of a laser of the spectrometer and to this extent have an effect on the measurement in that the light source modulation properties 14 of the spectrometer, that is falsifying influences on the wavelength modulation of the spectrometer, and the detection properties 16, that is substantially falsifying influences on the electronics of the spectrometer used, are determined by them. The measurement parameter 15 of the sample to be measured relevant to the determination of the concentration and/or composition of the gas is the number of particles N.

The carrying out of the measurement in accordance with FIG. 1 takes place by measuring an absorption signal which is subject to the influence of the named input values 11, 13, 15 in a different manner and to a different degree. The absorption signal is not directly recorded in wavelength modulation spectroscopy as a rule., but is rather converted into a first derivative signal xf from which a gas concentration measurement parameter is determined. This normally includes a norming of the derivative signal xf on a value proportional to the received intensity to obtain a derivative signal independent of intensity fluctuations due to contaminated windows or dust in the beam path. An area F(xf) 17 of the xf signal typically represents this gas concentration measurement parameter which can be derived from the first derivative signal xf and initially not only depends on the measurement parameter 15, but also on influences of the state variables 11 of the sample and of the device properties 13 of the spectrometer. The gas concentration measurement parameter derived from the measurement signals is liberated from falsifying influences of the state variables 11 of the sample and of the device properties 13 of the spectrometer using a calibration function K(p, T, X, F) 19 into which the state variables 11 of the sample and the surface 17 of the xf signal enter. This can, for example, take place by multiplication of the gas concentration measurement parameter by a correction factor corresponding to the calibration function 19 in such a case or in another and more complex manner. The result of the correction by the calibration function 19 is ultimately the concentration 21 and/or composition of the gas in the measured sample.

So that the calibration function 19 can satisfy this object of eliminating falsifying influences, it has to obtain and use, for example by the manner in which it is defined, information on how the state variables 11 and the device properties 13 act on the measurement signal. For this purpose, the calibration function 19 has to have been determined before the measurement as part of a calibration in which these relationships are determined by a plurality of calibration measurements under different conditions and by the comparison with reference measurements and flow into the calibration function 19. Because the device properties 13, however, vary over time, the calibration function 19 has to be redetermined regularly for the new device properties 13 which cannot simply be described as a parameter set.

The differences of the method in accordance with the invention from the procedure known in the prior art will be explained by a comparison of FIG. 2 with FIG. 1: In the routine of a measurement shown in FIG. 2, the same state variables 11 of the sample, the same device properties 13 of the respective spectrometer, which in turn have an influence on the measurement signal via the light source modulation properties 14 and the detection properties 16 of the spectrometer, and the same measurement parameter 15 of the sample forming the basis for the result to be measured are assumed. These parameters in turn have an influence on a measurement absorption signal which, in accordance with the basic principles of wavelength modulation spectroscopy does not enter directly into the evaluation, but in the form of derivative signals.

A first derivative signal xf is in turn the starting point for deriving a gas concentration measurement parameter in the form of an area F(xf) 17 of the xf signal. In the method described in FIG. 2, unlike the method in accordance with FIG. 1, however, not only one area F(xf) 17 of the xf signal us used as the gas concentration measurement parameter. The absorption signal is rather converted into at least one further derivative signal yf. The xf signal can, for example, be the 2f signal and the yf signal can be the 3f signal. The areas F(xf) 17 and F(yf) 17 can then be offset to form a relationship V 23 which is here formed as a simple quotient F(xf)/F(yf) of the two areas 17. In addition, the determination of further areas F(y′f) 17′ with respect to further derivative signals y′f can also be provided which can likewise enter into the relationship V 23 (shown dashed). In addition, a width B(zf) 25 of a derivative signal 2f is determined as a third gas concentration measurement parameter, with zf being able to be identical to or different from xf or yf.

In the embodiment shown in FIG. 2, three gas concentration measurement parameters 17, 23, 25 therefore enter into the calibration function 19. In the present case, these gas concentration measurement parameters are an area 17, a relationship 23 of two areas 17 and a width 25 of respective derivative signals. It is actually advantageously made possible by this selection of such suitable gas concentration measurement parameters that the light source modulation properties 14 of the spectrometer are compensated as part of the subsequent use of the calibration function(s) 19 so that the measurement signal is admittedly still falsified by the device properties 13, but can now be liberated in a first step without consideration of the detection properties 16 first from the other influences (in particular for the state variables 11 of the gas and from the light source modulation properties 14).

In accordance with the invention, instead of the single calibration function 19 from FIG. 1, the use of two part calibration functions is provided, namely of a parent calibration function 27 and of a device calibration function 29, as shown in FIG. 2. In this respect, the state variables 11, the area 17 of the xf signal, the relationship 23 of the areas 17, 17 of the xf signal and of the yf signal as well as the width 25 of the zf signal enter into the parent calibration function K_{M}(p, T, X, F, V, B) 27 during the measurement. As presented above, this choice of the gas concentration measurement parameters entering into the parent calibration function represents a suitable possibility that the light source modulation properties 14 are compensated and the parent calibration function 27 is thus so-to-say decoupled from the device properties 13 of the spectrometer.

The detection properties 16 of the spectrometer not considered by the parent calibration function 27 are for this purpose taken into account by the device calibration function K_{G} 29. For this purpose, the detection properties 16 do not have to be transferred as parameters to the device calibration function 29 during the measurement, particularly since they are as a rule not present as such, but they are rather already taken into account and stored as a functional relationship in the device calibration function 29 by the determination thereof which has to be repeated regularly.

The two part calibration functions are thus suitable for the mutually independent elimination of different influences on the measurement signal. In this respect, the part calibration functions are complementary to one another since ultimately a liberation of the measurement signals from falsifying influences of both the state variables 11 of the sample and of the device properties 13 of the spectrometer which corresponds to the effect of the single calibration function 19 of FIG. 1 ultimately takes place by the use of both the parent calibration function 27 and of the device calibration function 29. For example, the parent calibration function 27 and/or the device calibration function 29 can each output a correction value which is applied, for instance by multiplication or by another mathematical operation, to the measurement signal or to the one or more gas concentration measurement parameters. The parent calibration function 27 and/or the device calibration function 29 can, however, also be applied directly, e.g. after one another, to the gas concentration measurement parameters, and can thus liberate them from the falsifying influences such that finally the information to be measured results, i.e. the concentration and/or the composition of the gas in the sample.

Even if the specific determination of the concentration and/or composition of a gas in a single measurement in accordance with the method in accordance with the invention may under certain circumstances be more complex with respect to the method known from the prior art to the extent that more intermediate steps take place by the calculation of the areas 17 of the xf or yf signals of the ratio 23 of these area 17 and of the width 25 of the zf signal, it is nevertheless a lot easier to carry out, particularly with the regular carrying out of measurements and calibrations by a user of the spectrometer. The named additional calculations can namely be automated and can be carried out with only little processing effort, for example in the spectrometer itself. This possible slight increase in effort is compensated by the advantage that the comparatively complex parent calibration function 27 only has to be determined once as a rule and not by the user of the spectrometer, whereas the device calibration function 29, which has to be determined regularly, can be determined substantially more simply, for instance by means of a two-point calibration, than the single calibration function 19 of the prior art.

For the purpose of the above text, the term “the sample” comprises, for example, a gas in a closed measurement space, but also a gas which is conducted through a measurement space, and whose concentration or composition is to be determined, that is, for example, gas or smoke in an exhaust gas passage or chimney.

1. A method of determining a concentration of a gas in a sample and/or of the composition of a gas by means of a spectrometer, the method comprising the steps:
measuring an absorption signal of the gas as a function of the wavelength, wherein the wavelength substantially continuously runs through a wavelength range and the continuous running through of the wavelength range is superimposed by a wavelength modulation, wherein the influence of the wavelength modulation on the absorption signal via the light source modulation properties and the detection properties of the spectrometer is dependent on the device properties of the respective spectrometer;
converting the absorption signal into at least one first derivative signal;
deriving a gas concentration measurement parameter from the first derivative signal;
determining at least one of the concentration and the composition of the gas from at least the gas concentration measurement parameter and from a calibration function by which influences of state variables of the gas and of the device properties of the respective spectrometer are compensated;
in which method the calibration function comprises a parent calibration function and a device calibration function, wherein the state variables of the gas and one or more gas concentration measurement parameters derived from respective derivative signals enter into the parent calibration function and are selected such that the light source modulation properties of the spectrometer are substantially compensated, and wherein the device calibration function takes account of the detection properties of the respective spectrometer.

2. The method in accordance with claim 1, wherein the wavelength substantially continuously runs through a wavelength range and the continuous running through of the wavelength range is superimposed by a harmonic wavelength modulation.

3. The method in accordance with claim 1, wherein the conversion of the absorption signal into at least one first derivative signal comprises that the derivative signal is normed to a value proportional to the light intensity.

4. The method in accordance with claim 1, wherein the state variables of the gas comprise at least one member of the group containing a pressure, a temperature of the sample and a carrier gas influence.

5. The method in accordance with claim 4, wherein the carrier gas influence does not have to be present as a state variable.

6. The method in accordance with claim 1, wherein the light source modulation properties of the respective spectrometer are properties of a light source of the spectrometer and/or the detection properties of the respective spectrometer are properties of the electronics of the spectrometer.

7. The method in accordance with claim 1, wherein the device calibration function is determined by a two-point calibration.

8. The method in accordance with claim 7, wherein the two-point calibration comprises a measurement of the gas or of a reference gas at a first and/or second gas concentration.

9. The method in accordance with claim 8, wherein the two-point calibration comprises a measurement of the gas or of a reference gas at approximately 0% and at approximately 70% of a maximum reliably measurable concentration of this gas.

10. The method in accordance with claim 1, wherein at least one area of the first derivative signal or a value proportional to the area of the first derivative signal enters into the parent calibration function as the gas concentration measurement parameter.

11. The method in accordance with claim 1, wherein the method furthermore comprises the steps of:
converting the absorption signal into a second derivative signal and entering at least one ratio of an area of the first derivative signal and of an area of the second derivative signal into the parent calibration function as the gas concentration measurement parameter.

12. The method in accordance with claim 10, wherein the area of the first derivative signal and/or an area of a second derivative signal is/are derived from the spacing of a maximum of the respective derivative signal from a minimum of the respective derivative signal or from areas enclosed between the x axis and the respective derivative signal.

13. The method in accordance with claim 1, wherein at least one width of the first derivative signal enters into the parent calibration function as the gas concentration measurement parameter.

14. The method in accordance with claim 13, wherein the width of the first derivative signal is a full width at half maximum of an extreme of the first derivative signal or a spacing between two extremes of the first derivative signal, between two zero crossings of the first derivative signal or between a derivative and a zero crossing of the first derivative signal.

15. The method in accordance with claim 1, wherein the parent calibration function is determined by a plurality of measurements on the presence of different combinations of state variables of a respective sample.

16. A spectrometer for carrying out a method of determining a concentration of a gas in a sample and/or of the composition of a gas, method comprising the steps:
measuring an absorption signal of the gas as a function of the wavelength, wherein the wavelength substantially continuously runs through a wavelength range and the continuous running through of the wavelength range is superimposed by a wavelength modulation, wherein the influence of the wavelength modulation on the absorption signal via the light source modulation properties and the detection properties of the spectrometer is dependent on the device properties of the respective spectrometer;
converting the absorption signal into at least one first derivative signal;
deriving a gas concentration measurement parameter from the first derivative signal;
determining at least one of the concentration and the composition of the gas from at least the gas concentration measurement parameter and from a calibration function by which influences of state variables of the gas and of the device properties of the respective spectrometer are compensated;
in which method the calibration function comprises a parent calibration function and a device calibration function, wherein the state variables of the gas and one or more gas concentration measurement parameters derived from respective derivative signals enter into the parent calibration function and are selected such that the light source modulation properties of the spectrometer are substantially compensated, and wherein the device calibration function takes account of the detection properties of the respective spectrometer.

17. The spectrometer in accordance with claim 16, the spectrometer comprising a laser and the absorption signal resulting from the absorption of light of this laser by the gas.

18. The spectrometer in accordance with claim 17, in which the laser is a diode laser.

19. The spectrometer in accordance with claim 16, wherein the parent calibration function is substantially permanently stored in the spectrometer.
